(19) United States
(12) Patent Application Publication
(10) Pub. No.: US 2010/0054995 A1
(43) Pub. Date: Mar. 4, 2010

(54) METHOD FOR ALIGNING CARBON NANOTUBES IN MICROFLUIDIC CHANNEL

(75) Inventor: Sunghoon Kwon, Seoul (KR)

Correspondence Address: Sunghoon Kwon;Faculty APT 1221-104, San 4-2, Bongchun 7 Dong, Gwanak-Gu, Seoul, KR

(73) Assignee: Seoul National University Industry Foundation

(21) Appl. No.: 12/199,175

(22) Filed: Aug. 27, 2008

(51) Int. Cl. B01J 19/00; B05D 7/24

(52) U.S. Cl. 422/68.1; 427/181; 977/742

(57) ABSTRACT

A method includes aligning nanotubes in a microfluidic channel including supplying nanotubes to the microfluidic channel; forming at least one interface in the channel; and applying a pressure to the microfluidic channel to control orientation of the nanotubes. A microfluidic device includes a silicon chip having a outer surface further including an upper surface and a lower surface; an upper wafer attached to the upper surface of the silicon chip; and a lower wafer attached to the lower surface of the silicon chip; wherein: the silicon chip, upper wafer, and lower wafer form a microfluidic channel; one or more nanotubes are aligned on the silicon chip according to the method; and the outer surface includes probe molecules.

### BACKGROUND

Carbon nanotubes (CNT) are carbon allotropes found in abundance all over the world. Carbon nanotubes are formed in such a manner that one carbon element is bonded to other carbon elements while making a hexagonal honeycomb-pattern in a tube-shape and the diameter of a CNT is in the order of a few nanometers.

When a CNT is used as a semiconductor material, a memory device or a circuit having a nano-scale width can be manufactured. Such memory devices or circuits have a width smaller than that of an existing integrated circuits. The electrical properties of CNTs may be changed upon interaction between the CNTs, thereby generating a doping effect without being conventionally doped. Conventional doping processes, which are required when using a silicon material, can be omitted when using CNTs. Accordingly, the manufacturing of semiconductor devices can be simplified. The bonding between carbon atoms is much stronger in comparison to silicon atoms in a silicon surface. Semiconductor devices produced from CNTs can emit heat due to the high thermal conductivity of CNTs.

### SUMMARY

In one aspect, a method includes aligning nanotubes in a microfluidic channel. In some embodiments, the method includes supplying nanotubes to the microfluidic channel; forming at least one interface in the channel; and applying a pressure to the microfluidic channel to control orientation of the nanotubes. In some embodiments, the microfluidic channel is formed in a digital microfluidic device. In other embodiments, a shape of the interface is convex, concave, or flat. In other embodiments, the interface includes at least one air-water interface. In other embodiments, forming at least one interface includes generating a plurality of air bubbles into the microfluidic channel. In other embodiments, applying a pressure to the microfluidic channel includes controlling movement velocity of the interface by adjusting a velocity of fluid in the microfluidic channel. In yet other embodiments, the nanotubes comprise carbon nanotubes. In some other embodiments, one or more probes are supplied to a wall of the microfluidic channel. In some other embodiments, the carbon nanotubes are bonded to the probes. In further embodiments, the probes include DNA, RNA, or a protein.

In another aspect, a method is provided including binding nanotubes to a surface of a microfluidic channel. In some embodiments, the method includes, forming at least one meniscus in the microfluidic channel, where the microfluidic channel includes the nanotubes included in the microfluidic channel; and controlling the meniscus to obtain a desired arrangement of the nanotubes. In some embodiments, forming at least one meniscus includes injecting a plurality of air bubbles into the microfluidic channel. In some other embodiments, the nanotubes adhere to a surface of the microfluidic channel through movement of two or more meniscuses. In some other embodiments, controlling the meniscus includes controlling at least one of a width of the microfluidic channel and a velocity of fluid in the microfluidic channel.

In another aspect, a method is provided including improving alignment of nanotubes in a microfluidic channel, including generating at least one meniscus in the microfluidic channel, where the microfluidic channel includes the nanotubes; and controlling a movement of the meniscus to align the nanotubes. In some embodiments, the nanotubes are aligned in parallel with a surface of the microfluidic channel.

In another aspect, a nanotube circuit fabricated by using the methods is provided.

In another aspect, a microfluidic device includes a silicon chip having a outer surface further including an upper surface and a lower surface; an upper wafer attached to the upper surface of the silicon chip; and a lower wafer attached to the lower surface of the silicon chip; where: the silicon chip, upper wafer, and lower wafer form a microfluidic channel; one or more nanotubes are aligned on the silicon chip according to the method of claim 1; and the outer surface includes probe molecules.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is illustrative of a sectional view of a microfluidic channel for performing a method for aligning nanotubes according to one embodiment.

FIG. 2 is a concept view illustrating a method for aligning nanotubes in a microfluidic channel according to one embodiment.

FIGS. 3A, 3B, and 3C are views each illustrating the meniscus formed in a microfluidic channel according to embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In one aspect, a method for aligning nanotubes in a microfluidic channel comprises supplying nanotubes to the microfluidic channel; forming at least one interface in the microfluidic channel; and applying a pressure to the microfluidic channel to control orientation of the nanotubes.

The nanotubes may include CNTs. As used herein, CNTs are as defined above. According to some embodiments, CNTs are from about 1 nm to 100 nm in width and from about 100 nm to 500 nm in length. According to other embodiments, CNTs are from about 100 nm to 200 nm in width and from about 500 nm to 1000 nm in length. Although CNTs are illustrated in this embodiment, nanotubes or nanowires made from other material, such as gold and silver may be used in another embodiment.

The microfluidic channel of the method may be formed in a digital microfluidic device. As used herein, a microfluidic channel means any type of microfabricated channel in which fluids flow at the microscale. The digital microfluidic device means a lab-on-a-chip system based upon on micromanipulation of individual droplets. The digital microfluidic device performs a microfluidic process by each individual scheme respective to each unit-sized fluid packet, which is moved, reacts, is mixed, and is analyzed. Therefore, a plurality of droplets using a surface tension of liquid is formed within the microfluidic channel of the digital microfluidic device. In response to the droplets, a meniscus, which will be described later, is formed in the microfluidic channel of the digital microfluidic device. Thus, the shape of the meniscus can be controlled by adjusting movement velocity of the droplets. In the digital microfluidic device, the shape of meniscus can be sophisticatedly controlled in such a manner that hydrophobicity of a substrate is controlled by using an electric field. For example, the substrate will be extremely hydrophobic when no field is applied, but a polarized hydrophilic surface is created when a field is applied. Further, it is possible to control the shape of meniscus by controlling the localization of this polarization

The interface in the microfluidic channel is defined as a surface formed between two immiscible phases. For example, the interface may include at least one air-water interface or at least one oil and water interface. In one embodiment, the shape of the interface is convex. In one embodiment, the shape of the interface is concave. In one embodiment, the shape of the interface is flat.

In one embodiment, the interface is included in a meniscus formed in the microfluidic channel. The meniscus means a curve in the surface of a liquid and is produced in response to the surface of the microfluidic channel. In one embodiment, the meniscus may be formed in response to the air bubbles provided into the microfluidic channel. The air bubble may be provided into the channel in response to a pressure applied from an outside into the channel. In this case, the meniscus may have an air-liquid interface. In another embodiment, the meniscus may be formed in response to the existence of two immiscible liquid phases, for example, water and organic solvent. For example, in stead of providing air into the microfluidic channel through which a CNTs solution flows, an organic solvent, which is not mixed with water, may be provided into the microfluidic channel through which a CNTs aqueous solution. The organic solvent may include, but is not limited to, tetrahydrofuran, chloroform, dichloromethane, toluene or xylene. In this case, the meniscus may have a liquid-liquid interface, for example, water-oil interface.

In the case that the interface includes an air-liquid interface, the movement velocity of the interface may be controlled by adjusting the applying the pressure into the microfluidic channel. For example, the amount of air bubbles or the speed of the formation of the air bubbles may depend on the amount of the external pressure provided into the microfluidic channel or the speed of applying the pressure into the microfluidic channel. For example, as the amount of the pressure provided into the microfluidic channel is greater, the amount of air bubbles formed in the channel is greater. Further, as the speed of the pressure applied into the channel is faster, the velocity of fluid in the microfluidic channel is faster. As a result, the movement of the meniscus flowing in the fluid is increased. Thus, by controlling the amount of the pressure applied into the microfluidic channel or the speed of applying the pressure into the microfluidic channel, the movement velocity of the meniscus having the interface may be controlled.

The method also includes providing probes to a wall of the microfluidic channel. In some embodiments, the CNTs are bonded to the probes. The probe means any type of biological binders that can chemically or biologically react with the nanotube. For example, the probe may include a nucleic acid having a complementary sequence if the nanotube flowing in the microfluidic channel is a nucleic acid. In other embodiments, the probes may include, but is not limited to, DNA, RNA, or a protein.

The probes may be provided into the microfluidic channel, for example, by patterning a probe on the surface of the microfluidic channel, or by injecting a probe solution into the microfluidic channel after manufacturing the microfluidic channel. For example, the microfluidic channel may be manufactured to have probes on a surface of the channel.

In some embodiments, the probe adhered to the surface of the microfluidic channel can react with a nanotube moving with a meniscus. Therefore, a nanotube may be aligned in a desired direction by adhering a probe, which reacts with the nanotube, at a specific position of the microfluidic channel, and moving the nanotube to the specific position by controlling the movement of the meniscus. Because the nanotube reacts with the probe adhered to the specific position, the nanotube can be adhered to the specific position, thereby aligning the nanotubes in a desired direction.

In another aspect, a method for binding nanotubes to a surface of a microfluidic channel includes forming at least one meniscus in the microfluidic channel, which includes nanotubes, and controlling the meniscus to obtain a desired arrangement of the nanotubes.

As described above, at least one meniscus may be formed by injecting air bubbles into the microfluidic channel. The air bubbles are injected into the channel by applying a pressure into the channel. The at least one meniscus may have the air-liquid interface, as described above. Because of the tension at the air-liquid interface, the nanotubes may gather around the air-liquid interface. Thus, the nanotubes may move according to the movement of the meniscus. For example, the nanotubes arrangement in the microfluidic channel may depend on the movement velocity or shape of the meniscus. Accordingly, by controlling the movement of the meniscus, the nanotubes may be arranged in a desired orientation. For example, the movement of the meniscus may be controlled by controlling the width of the microfluidic channel or a velocity of fluid in the channel.

In another aspect, a method for improving the alignment of nanotubes within a microfluidic channel includes generating at least one meniscus in the microfluidic channel, which includes nanotubes; and controlling a movement of the meniscuses to align the nanotubes. The meniscus can have a convex, concave, or flat interface. The shape of the meniscus can be adjusted into a desired shape by controlling the velocity of a fluid flowing through the channel, which will be described later. By controlling the shape of the meniscus, the CNTs can be aligned in a desired direction. For example, the nanotubes may be aligned in parallel with a surface of the microfluidic channel when the meniscus has a flat interface.

In another aspect, a nanotube circuit is fabricated by using the above-described methods. A nanotube circuit may be implemented by aligning nanotubes on a substrate through meniscus movement within a microfluidic channel by using the above described schemes, and evaporating the liquid flowing through the channel.

In another aspect, a microfluidic device includes a silicon chip including a solid surface, to which probe molecules are attached; and an upper wafer and a lower wafer attached to an upper surface and a lower surface of the silicon chip, respectively, to form a microfluidic channel, wherein nanotubes are aligned on the silicon chip according to the above-described methods. In one embodiment, a microfluidic device may include a silicon chip and upper and lower wafers. The silicon wafer has a solid surface on which probe molecules are adhered. The upper and lower wafers are attached to an upper surface and a lower surface of the silicon chip, respectively. As a result, a microfluidic channel is formed. A fluid including nanotubes may be provided into this channel. The nanotubes may be aligned on the silicon chip in a desired direction through meniscus movement, as described below.

In another embodiment, the method described above may be applied to nanowires, as well as nanotubes. The similar method may be used in arranging the nanowires in a desired direction or a desired shape.

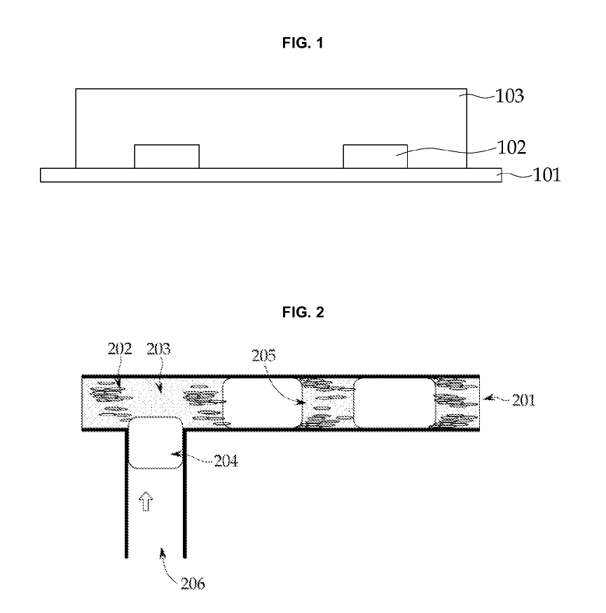

Referring now to the figures, FIG. 1 is a sectional view of a microfluidic channel, at which nanotubes are introduced and aligned according to one embodiment. The microfluidic channel may be manufactured by applying polydimethylsiloxane (PDMS) 103 having a pattern of a channel-type on a silicon or a glass surface 101 with a conformal contact method. For example, microfluidic channel is formed by exposing PDMS 103 to oxygen plasma and then PDMS 103 can be adhered to a silicon or a glass surface 101. PDMS 103 mold is fabricated using various plastic molding method, such as casting, injection and hot-embossing. Although not shown, the liquid including nanotubes may flow into a microfluidic channel 102 through an inlet (not shown) connected to the microfluidic channel 102.

FIG. 2 is a concept view illustrating a method for aligning nanotubes in the microfluidic channel according to one embodiment. As illustrated in FIG. 2, a CNT solution 203 is introduced into a first microfluidic channel 201. The CNT solution 203 is formed by dispersing CNTs 202 in water. Although water is used to disperse CNTs in the embodiment, other organic solvents, such as tetrahydrofuran, chloroform, dichloromethane, toluene and xylene, can be used as long as the CNTs are dispersed in the solvent or other fluid. The CNT solution 203 may be introduced into the first microfluidic channel 201 by using any type of liquid injector, for example, injection syringes, injection cannulas and injection pumps. As the CNT solution 203 is introduced into the first microfluidic channel 201, it contacts a wall of the first microfluidic channel 201, and a meniscus 205 is formed in the channel 201. The meniscus 205 has the interface of the air and liquid phases, that is, the interface of the air 204 and the CNT solution 203.

The meniscus 205 generated by introduction of the CNT solution 203, quickly disappears. Therefore, to retain the meniscus 205, air needs to be provided into the first microfluidic channel 201 from outside the microfluidic channel 201. For example, as illustrated in FIG. 2, air 204 may be provided in the first microfluidic channel 201 through a second microfluidic channel 206 connected to the first microfluidic channel 201. The arrow in FIG. 2 indicates the direction that the air is provided to the first microfluidic channel 201 through the second microfluidic channel 206. Although FIG. 2 illustrates that the first microfluidic channel 201 and the second microfluidic channel 206 are connected with each other in a T-shape, the shape of such connection can be any shape, such as a Y-shape, as long as such connection allows external air to be provided into the first microfluidic channel 201. Thus, by using the air provided from outside, the meniscus 205 does not disappear and is continuously generated within the first microfluidic channel 201.

The meniscus 205 moves in the first microfluidic channel 201, together with the CNTs 202 included in the CNT solution 203. Tension is generated by an air-liquid interface of the meniscus 205, and the CNTs 202 flowing in fluid are aligned around the air-liquid interface by the tension. With meniscus movement, the CNTs 202 are aligned on the surface of the channel 201. For example, by generating multiple meniscuses, and then performing multiple movements of the meniscuses, the CNTs 202 can be aligned on the surface of the channel 201. Multiple meniscus movement can be performed to align the CNTs 202 by generating multiple meniscuses.

The degree of movement of the meniscus 205 can be changed according to the number of meniscuses 205 and the speed of movement of the meniscuses 205. For example, if the amount of air 204 provided from the second microfluidic channel 206 is large, the number of meniscuses 205 formed within the first microfluidic channel 201 increases in proportion to the amount of the air. Moreover, if the speed of providing air 204 into the second microfluidic channel 206 is increased, the speed of providing the air 204 into the first microfluidic channel 201 is also increased. Accordingly, the speed of moving the CNTs 202 is also increased. The desired speed of movement the CNTs can thus be obtained by controlling the amount of air 204 provided into the first microfluidic channel 201, and by the speed of the air that is provided.

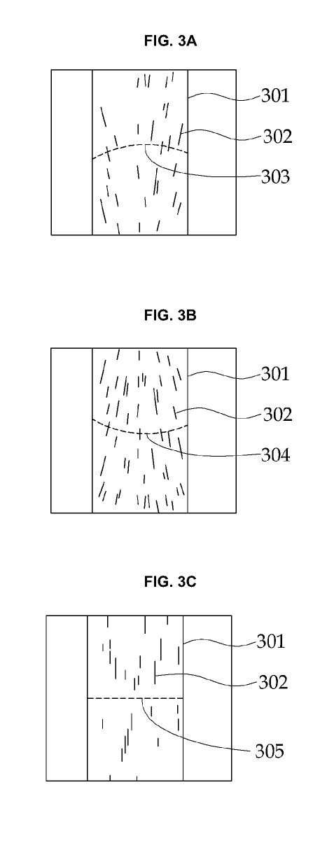

With reference to FIGS. 3A, 3B, and 3C, the method for aligning CNTs within a microfluidic channel is described. Three types of meniscuses 303, 304 and 305 are illustrated as a dotted line in FIGS. 3A, 3B, and 3C. The meniscuses 303, 304 and 305 are positioned at the middle of the microfluidic channels 301, respectively. The meniscuses 303, 304, and 305 have a convex interface (FIG. 3A), a concave interface (FIG. 3B), and a flat interface (FIG. 3C), respectively. In FIGS. 3A, 3B, and 3C, the lines arranged within the microfluidic channel 301 in a predetermined direction show CNTs 302. Each microfluidic channel 301 shown in FIGS. 3A, 3B, and 3C has, for example, a depth of about 30 to 50 μm and a width of about 80 to 120 μm.

In particular, FIG. 3A illustrates a meniscus 303 having a convex interface. The convex interface is generated when a CNT solution voluntarily moves at the speed of, for example, about 0.4 μm/s to 0.6 μm/s, due to a capillary phenomena. No external pressure is applied to the microfluidic channel 301. As shown in FIG. 3A, due to the meniscus 303 having the convex interface, the CNTs 302 are aligned in a direction perpendicular to the meniscus 303.

FIG. 3B shows a meniscus 304 having a concave interface. The concave interface is generated when the CNT solution moves at the speed of, for example, about 80 μm/s to 100 μm/s, in a case where an external pressure is applied to the channel 301. As shown in FIG. 3B, due to the meniscus 304 having the concave interface, the CNTs 302 are aligned in a direction perpendicular to the meniscus 304. The aligned direction of the CNTs 302 in FIG. 3B is symmetrical to the aligned direction of the CNTs 302 in FIG. 3A.

FIG. 3C illustrates a meniscus 305 having a flat interface. The flat interface is generated when the CNT solution moves at the speed of, for example, about 3 μm/s to 5 μm/s, in a case where an external pressure is applied to the channel 301. The external pressure applied in the channel 301 of FIG. 3C is smaller than that applied in the channel 301 of FIG. 3B. As shown in FIG. 3C, the aligned direction of the CNTs 302 is perpendicular to the meniscus 305. That is, the CNTs 302 are aligned in parallel with a surface of the channel 301 due to the meniscus 305 having the flat interface.

The meniscus having an interface, formed by two kinds of states (e.g. liquid-gas), aligns the CNTs in a direction perpendicular to the meniscus through movement of the CNTs in the microfluidic channel. Therefore, the shape of the meniscus can be adjusted into a concave, convex, or flat shape by controlling the velocity of a fluid flowing through the channel. By controlling the shape of the meniscus, the CNTs can be aligned in a desired direction.

According to another embodiment, the shape of the meniscus can be changed by controlling the width of the channel without a change in the pressure applied to the microfluidic channel. If the width of the channel becomes narrower than a predetermined width, for example, about 80 to 120 μm, as illustrated in FIG. 3A, 3B, and 3C, the shape of the meniscus can be changed even if an external pressure is not applied to the channel. For example, if the width of the channel is relatively narrow, the flowing velocity of the fluid in the channel is increased due to capillary force. Therefore, the shape of the meniscus can be flat or concave. As illustrated in FIG. 3A, a convex interface is formed due to a capillary phenomenon without an external pressure applied to the channel. Therefore, if there is no external pressure, a flat air-liquid interface may be formed by properly adjusting the width of the channel. As a result, the CNTs can be aligned in parallel with a surface in the microfluidic channel.

As described above, an aligned direction of nanotubes depends on the shape of the meniscus as shown in FIGS. 3A, 3B, and 3C. Therefore, in order to align the nanotubes in a desired direction, the shape of the meniscus may be controlled. As described above, the shape of the meniscus can be controlled by changing the velocity of fluid flowing in the microfluidic channel and the width of the channel. The fluid velocity can be controlled by changing the pressure applied to the microfluidic channel. If no external pressure is applied to the microfluidic channel, the fluid can move due to the capillary force generated in the microfluidic channel. Also, the shape of the meniscus can be controlled by changing the width of the channel, without changing the depth of the microfluidic channel.

CNTs or nanowires may be aligned in a desired direction by using a method and an apparatus disclosed in the present disclosure. Therefore, a high assembling yield can be obtained by using the minimized amount of CNT or nanowire solution.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed invention. Additionally the phrase “consisting essentially of” will be understood to include those elements specifically recited and those additional elements that do not materially affect the basic and novel characteristics of the claimed invention. The phrase “consisting of” excludes any element not specifically specified.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
aligning nanotubes in a microfluidic channel comprising:
supplying nanotubes to the microfluidic channel;
forming at least one interface in the channel; and
applying a pressure to the microfluidic channel to control orientation of the nanotubes.

2. The method of claim 1, wherein the microfluidic channel is formed in a digital microfluidic device.

3. The method of claim 1, wherein a shape of the interface is convex, concave, or flat.

4. The method of claim 1, wherein the interface comprises at least one air-water interface.

5. The method of claim 1, wherein forming at least one interface comprises generating a plurality of air bubbles into the microfluidic channel.

6. The method of claim 1, wherein applying a pressure to the microfluidic channel comprises controlling movement velocity of the interface by adjusting a velocity of fluid in the microfluidic channel.

7. The method of claim 1, wherein the nanotubes comprise carbon nanotubes.

8. The method of claim 7, wherein one or more probes are supplied to a wall of the microfluidic channel.

9. The method of claim 8, wherein the carbon nanotubes are bonded to the probes.

10. The method of claim 8, wherein the probes include DNA, RNA, or a protein.

11. A method comprising
binding nanotubes to a surface of a microfluidic channel, comprising:
forming at least one meniscus in the microfluidic channel, wherein the microfluidic channel comprises the nanotubes included in the microfluidic channel; and
controlling the meniscus to obtain a desired arrangement of the nanotubes.

12. The method of claim 11, wherein forming at least one meniscus comprises injecting a plurality of air bubbles into the microfluidic channel.

13. The method of claim 12, wherein the nanotubes adhere to a surface of the microfluidic channel through movement of two or more meniscuses.

14. The method of claim 11, wherein controlling the meniscus comprises controlling at least one of a width of the microfluidic channel and a velocity of fluid in the microfluidic channel.

15. A method comprising:
improving alignment of nanotubes in a microfluidic channel, comprising
generating at least one meniscus in the microfluidic channel, wherein the microfluidic channel comprises the nanotubes; and
controlling a movement of the meniscus to align the nanotubes.

16. The method of claim 15, wherein the nanotubes are aligned in parallel with a surface of the microfluidic channel.

17. A nanotube circuit fabricated by using the method of claim 1.

18. A microfluidic device comprising:
a silicon chip having a outer surface further comprising an upper surface and a lower surface;
an upper wafer attached to the upper surface of the silicon chip; and
a lower wafer attached to the lower surface of the silicon chip;
wherein:
the silicon chip, upper wafer, and lower wafer form a microfluidic channel;
one or more nanotubes are aligned on the silicon chip according to the method of claim 1; and
the outer surface comprises probe molecules.
